(19) United States
(12) Patent Application Publication
(10) Pub. No.: US 2024/0113794 A1
(43) Pub. Date: Apr. 4, 2024

(54) METHOD AND APPARATUS FOR PREDICTING CSI IN CELLULAR SYSTEMS

(71) Applicant: Samsung Electronics Co., Ltd., Suwon-si (KR)

(72) Inventor: Jeongho Jeon, San Jose, CA (US)

(21) Appl. No.: 18/467,674

(22) Filed: Sep. 14, 2023

Related U.S. Application Data
(60) Provisional application No. 63/411,216, filed on Sep. 29, 2022.
(60) Provisional application No. 63/412,147, filed on Sep. 30, 2022.

(51) Int. Cl. H04B 17/373; H04L 5/00; H04W 24/02

(52) U.S. Cl. CPC H04B 17/373; H04L 5/0051; H04W 24/02

(57) ABSTRACT

Method and apparatuses for predicting channel state information (CSI) feedback in cellular systems. A method for a user equipment (UE) to report CSI includes receiving first information related to monitoring a performance of a machine learning (ML) model for predicting CSI, second information related to transmitting a performance monitoring report, third information related to reception of CSI reference signals (CSI-RSs) for determining a ground-truth CSI on a cell, and the CSI-RSs based on the third information. The method further includes determining the ground-truth CSI based on the reception of the CSI-RSs and a performance monitoring report for the ML model based on the first information and the ground-truth CSI. The method further includes transmitting a channel with the performance monitoring report based on the second information.

### CROSS-REFERENCE TO RELATED AND CLAIM PRIORITY

The present application claims priority under 35 U.S.C. § 119(e) to U.S. Provisional Patent Application No. 63/411,216 filed on Sep. 29, 2022, and U.S. Provisional Patent Application No. 63/412,147 filed on Sep. 30, 2022, which are hereby incorporated by reference in their entirety.

### TECHNICAL FIELD

The present disclosure relates generally to wireless communication systems and, more specifically, the present disclosure relates to methods and apparatuses for predicting future channel state information (CSI) in cellular systems.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to methods and apparatuses for predicting CSI in cellular systems.

In one embodiment, a method for a user equipment (UE) to report CSI is provided. The method includes receiving first information related to monitoring a performance of a machine learning (ML) model for predicting CSI, second information related to transmitting a performance monitoring report, third information related to reception of CSI reference signals (CSI-RSs) for determining a ground-truth CSI on a cell, and the CSI-RSs based on the third information. The method further includes determining the ground-truth CSI based on the reception of the CSI-RSs and a performance monitoring report for the ML model based on the first information and the ground-truth CSI. The method further includes transmitting a channel with the performance monitoring report based on the second information.

In another embodiment, a UE is provided. The UE includes a transceiver configured to receive first information related to monitoring a performance of a ML model for predicting CSI, receive second information related to transmitting a performance monitoring report, receive third information related to reception of CSI-RSs for determining a ground-truth CSI on a cell, and receive the CSI-RSs based on the third information. The UE further includes a processor operably coupled to the transceiver. The processor is configured to determine the ground-truth CSI based on the reception of the CSI-RSs and determine a performance monitoring report for the ML model based on the first information and the ground-truth CSI. The transceiver is further configured to transmit a channel with the performance monitoring report based on the second information.

In yet another embodiment, a base station is provided. The base station includes a transceiver configured to transmit first information related to monitoring a performance of a ML model for predicting CSI, transmit second information related to transmitting a performance monitoring report, transmit third information related to transmission of CSI-RSs for determining a ground-truth CSI on a cell, transmit the CSI-RSs based on the third information, and receive, based on the second information, a channel with the performance monitoring report for the ML model based on the first information and the ground-truth CSI.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a diagram showing artificial intelligence (AI)/machine learning (MIL)-based CSI feedback according to embodiments of the present disclosure;

FIG. 7 illustrates an example of a timeline for CSI measurement and reporting according to embodiments of the present disclosure;

FIG. 8 illustrates a procedure of an example CSI prediction and a transmission of the predicted CSI at a UE, and a reception the predicted CSI at a network according to embodiments of the present disclosure;

FIG. 9 illustrates a procedure of an example CSI prediction performed at a UE according to embodiments of the present disclosure;

FIG. 10 illustrates a flowchart of an example UE procedure for CSI prediction according to embodiments of the present disclosure;

FIG. 11 illustrates an example timeline of CSI measurement window and CSI prediction window indications according to embodiments of the present disclosure;

FIG. 12 illustrates an example timeline of indicating instances for CSI prediction according to embodiments of the present disclosure;

FIG. 13 illustrates a procedure of an example CSI prediction at a network according to embodiments of the present disclosure;

FIG. 14 illustrate a procedure of an example CSI prediction performed at a network according to embodiments of the present disclosure;

FIG. 15 illustrates a flowchart of an example UE procedure for providing assistance information to a network for CSI prediction according to embodiments of the present disclosure;

FIG. 16 illustrates a flowchart of an example UE procedure for supporting lifecycle management for CSI prediction according to embodiments of the present disclosure;

FIG. 17 illustrates a flowchart of an example UE procedure for monitoring the CSI prediction performance according to embodiments of the present disclosure;

FIG. 18 illustrates an example timeline of CSI prediction performance monitoring according to embodiments of the present disclosure; and

FIG. 19 illustrates an example timeline of measuring and filtering CSI prediction performance according to embodiments of the present disclosure.

### DETAILED DESCRIPTION

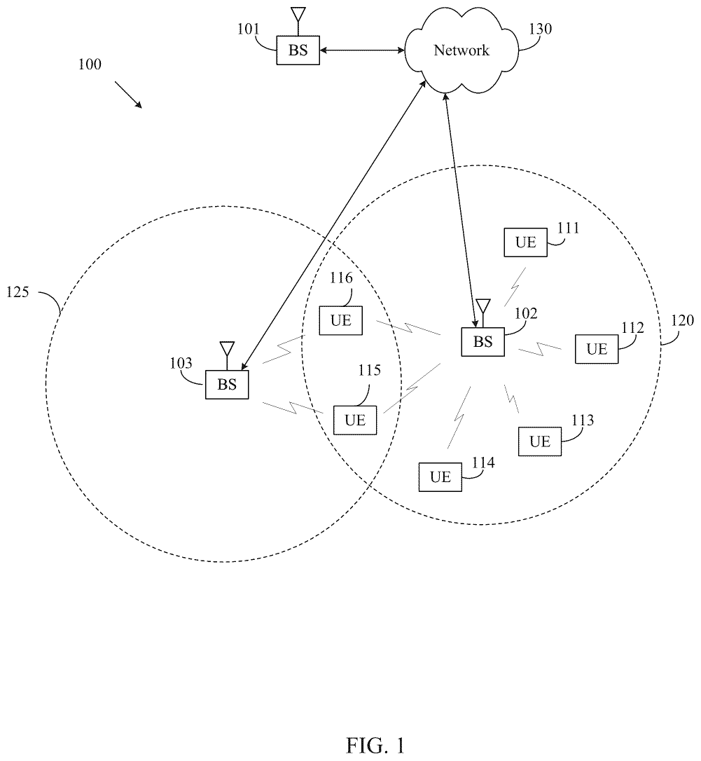

FIGS. 1-19, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.2.0, “NR; Physical channels and modulation;” [2] 3GPP TS 38.212 v17.2.0, “NR; Multiplexing and Channel coding;” [3] 3GPP TS 38.213 v17.2.0, “NR; Physical Layer Procedures for Control;” [4] 3GPP TS 38.214 v17.2.0, “NR; Physical Layer Procedures for Data;” [5] 3GPP TS 38.215 v17.1.0, “NR; Physical layer measurements;” [6] 3GPP TS 38.331 v17.1.0, “NR; Radio Resource Control (RRC) protocol specification;” [7] 3GPP TS 38.321 v17.1.0, “NR; Medium Access Control (MAC) protocol specification;” [8] 3GPP TS 38.133 v17.6.0, “NR; Requirements for support of radio resource management.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for predicting future CSI in cellular systems. In certain embodiments, one or more of the BSs 101-103 include circuitry, programing, or a combination thereof to support predicting future CSI in cellular systems.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

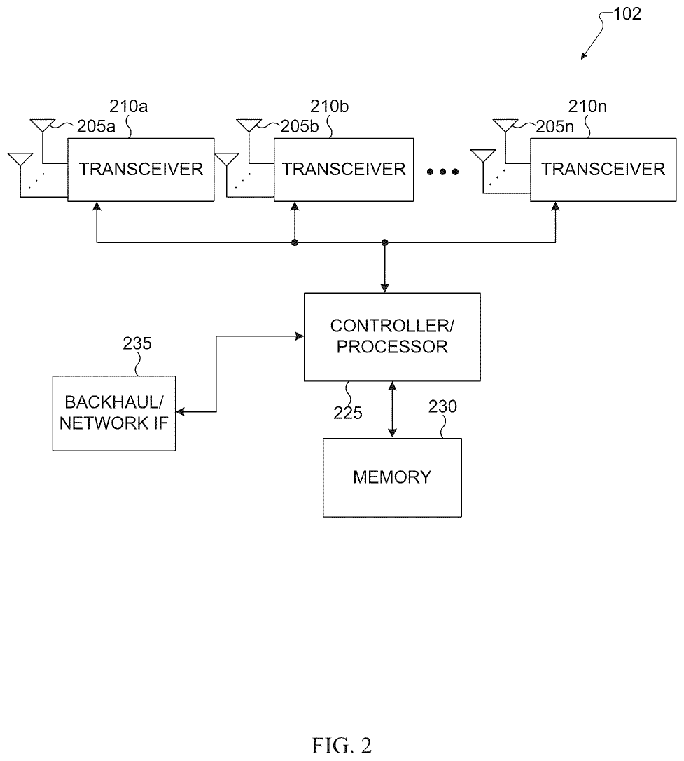

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting predicting future CSI in cellular systems. Any of a wide variety of other functions could be supported in the gNB 102 by the controller/processor 225.

The controller/processor 225 is also capable of executing programs and other processes resident in the memory 230, such as to support prediction of future CSI in cellular systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

In the present disclosure, an italicized name for a parameter implies that the parameter is provided by higher layers. DL transmissions or UL transmissions can be based on an OFDM waveform including a variant using discrete Fourier transform (DFT) precoding that is known as DFT-spread-OFDM that is typically applicable to UL transmissions.

In the present disclosure, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments examine a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

The MIMO technologies have been playing an important role in boosting system throughput both in NR and LTE and such a role will be continued and further expanded in the future generation wireless technologies.

An antenna port is defined such that the channel over which a symbol on the antenna port is conveyed can be inferred from the channel over which another symbol on the same antenna port is conveyed. There is not necessarily one to one correspondence between an antenna port and an antenna element, and a plurality of antenna elements can be mapped onto one antenna port.

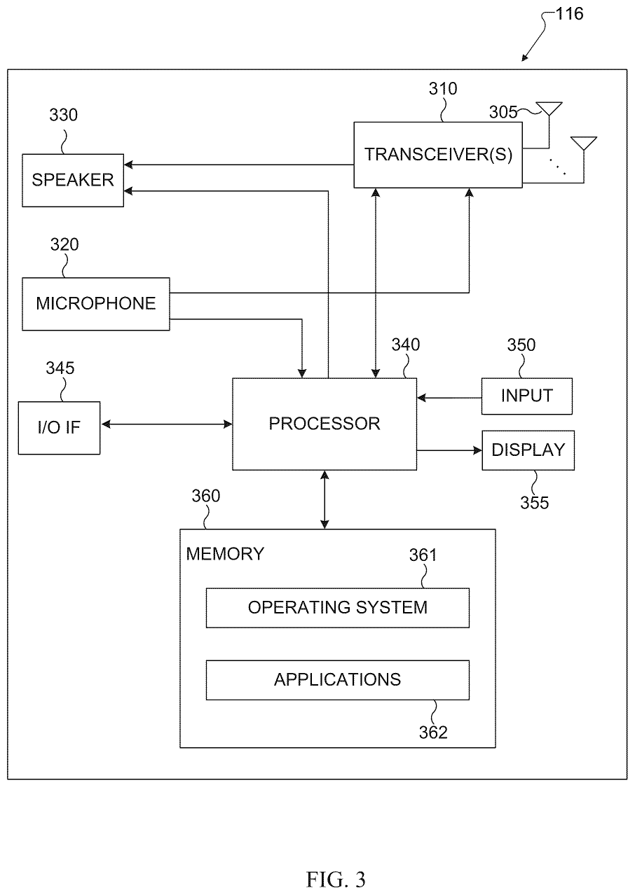

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for predicting future CSI in cellular systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

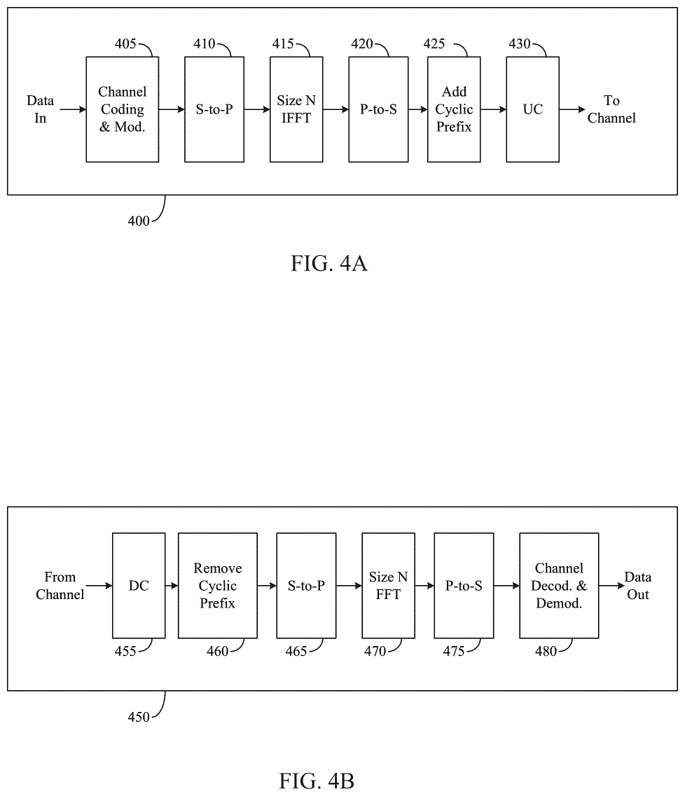

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured to support predicting future CSI in cellular systems as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

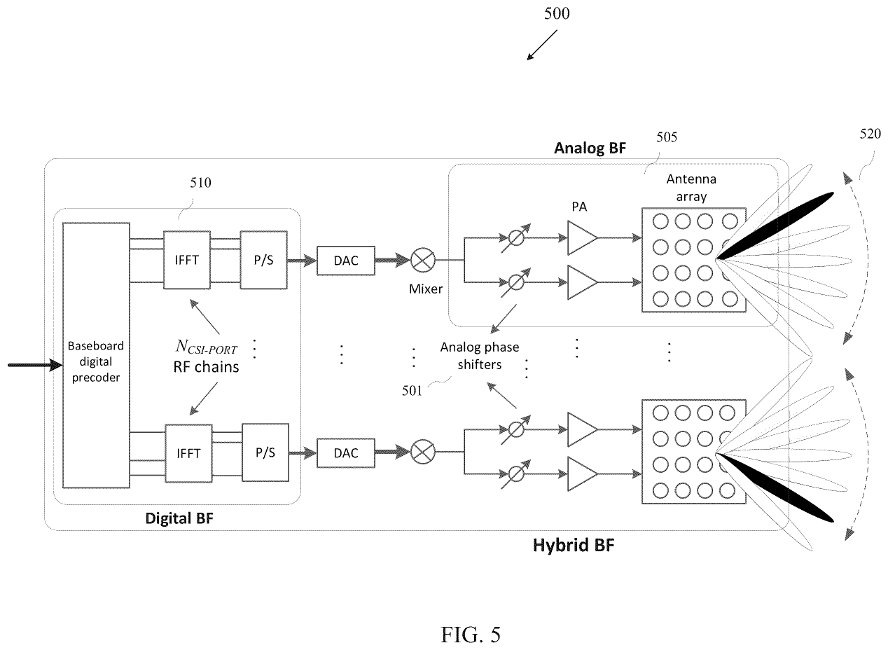

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosure herein that changes in the embodiments and examples shown may be made without departing from the scope of the present disclosure. The transmitter structure 500 for beamforming is for illustration only and other embodiments can be used without departing from the scope of the present disclosure.

To enable digital precoding, efficient design of CSI-RS is a crucial factor. For this reason, three types of CSI reporting mechanism corresponding to three types of CSI-RS measurement behavior are supported in Rel.13 LTE: 1) ‘CLASS A’ CSI reporting which corresponds to non-precoded CSI-RS, 2) ‘CLASS B’ reporting with K=1 CSI-RS resource which corresponds to UE-specific beamformed CSI-RS, 3) ‘CLASS B’ reporting with K>1 CSI-RS resources which corresponds to cell-specific beamformed CSI-RS. For non-precoded (NP) CSI-RS, a cell-specific one-to-one mapping between CSI-RS port and transceiver unit (TXRU) is utilized. Here, different CSI-RS ports have the same wide beam width and direction and hence generally cell-wide coverage. For beamformed CSI-RS, beamforming operation, either cell-specific or UE-specific, is applied on a non-zero-power (NZP) CSI-RS resource (including multiple ports). Here, (at least at a given time/frequency) CSI-RS ports have narrow beam widths and hence not cell-wide coverage, and (at least from the eNB perspective) at least some CSI-RS port-resource combinations have different beam directions. The basic principle remains the same in NR.

In scenarios where DL long-term channel statistics can be measured through UL signals at a serving gNB, UE-specific beamformed CSI-RS can be readily used. This is typically feasible when UL-DL duplex distance is sufficiently small. When this condition does not hold, however, some UE feedback is beneficial for the gNB to obtain an estimate of DL long-term channel statistics (or any of its representation thereof). To facilitate such a procedure, a first beamformed CSI-RS transmitted with periodicity T1 (ms) and a second NP CSI-RS transmitted with periodicity T2 (ms), where T1≤T2. This approach is termed hybrid CSI-RS. The implementation of hybrid CSI-RS is largely dependent on the definition of CSI process and NZP CSI-RS resource.

One of the important components of a MIMO transmission scheme is the accurate CSI acquisition at the gNB (or TRP). For multi-user (MU)-MIMO, in particular, the availability of accurate CSI is warranted in order to guarantee high MU performance. For time division duplexing (TDD) systems, the CSI can be acquired using the SRS transmission relying on the channel reciprocity. For frequency division duplex (FDD) systems, on the other hand, the CSI can be acquired using the CSI-RS transmission from gNB, and CSI acquisition and feedback from UE. In LTE up to Rel. 13, for FDD systems, the CSI feedback framework is ‘implicit’ in the form of channel quality information (CQI)/precoding matrix indicator (PMI)/rank indicator (RI) (and CSI-RS indicator (CRI) in Rel. 13) derived from a codebook assuming single user (SU) transmission from eNB. Because of the inherent SU assumption while deriving CSI, this implicit CSI feedback is inadequate for MU transmission. On the other hand, NR system has been designed to be more MU-centric from its first release with high resolution Type-II codebook in addition to low resolution Type-I codebook.

In the present network, the applications of AI/ML-based methods have been mostly limited to network layers. A virtualized RAN with open interfaces and network intelligence with entities such as Non-Real-Time (RT) RAN Intelligence Controller (RIC) and near-RT RIC has been defined by the O-RAN Alliance. The Non-RT RIC is a logical function that enables non-real-time control and optimization of RAN elements and resources, which governs the overall AI/ML workflow for an O-RAN network, including model training, inference, and updates. The Near-RT RIC is a logical function that enables near-real-time control and optimization of RAN elements and resources via fine-grained data collection and actions over the RAN interface. On the other hand, the 3GPP has defined Network Data Analytics Function (NWDAF) for network slice management in Rel-15 and it has been further enhanced in Rel-16 and Rel-17. The 3GPP also defined the functional framework for RAN intelligence enabled by data collection.

It is expected that AI/ML methods will be applied for various cellular system air interface designs including CSI compression/recovery, future CSI prediction, learning-based channel estimation, channel coding, and modulation, just to name a few. Common physical layer algorithms have been derived based on the simplifying assumptions such as linear system model, Additive White Gaussian Noise (AWGN) channel, etc. By exploiting AI/ML methods, an optimal algorithm can be developed for more practical system assumptions such as nonlinearity, and fading channels, etc.

It is also expected that, depending on the use cases, the improvements can be not only on the system performance such as throughput, spectral efficiency, and latency but also on the complexity, reliability, and overhead, etc. Moreover, the optimization can be done not only in the piecewise manner for a given transmitter/receiver processing function but also in the end-to-end manner including the entire transmitter/receiver processing chains. Therefore, it is expected that the scope of AI/ML application in the cellular system will be continuously expanded.

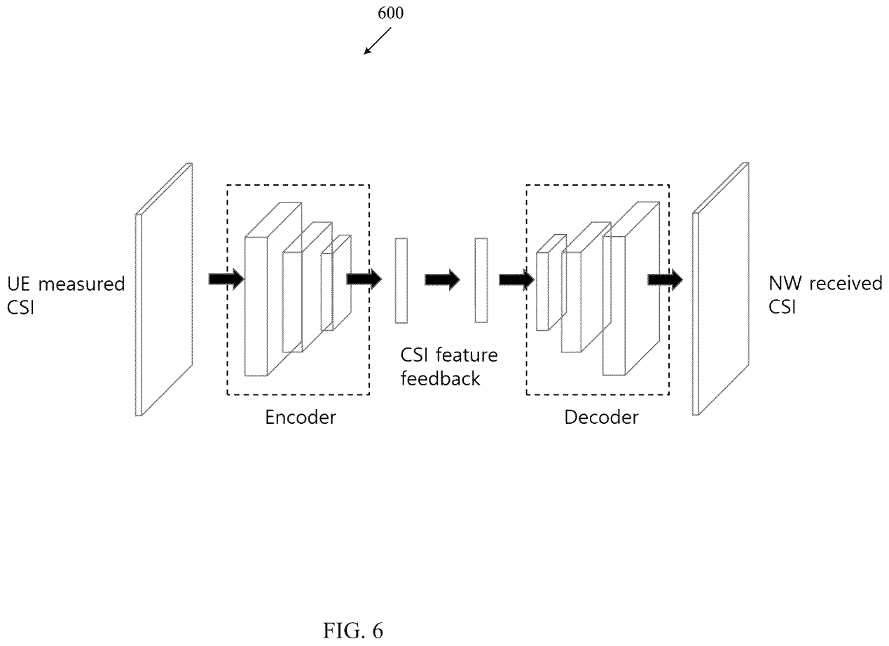

FIG. 6 illustrates an example of a diagram 600 showing AI/ML-based CSI feedback according to embodiments of the present disclosure. For example, the AI/ML-based CSI feedback shown in diagram 600 may be performed between the gNB 102 and/or network 130 and the UE 116 in the wireless network 100 of FIG. 1. This example is for illustration only and can be used without departing from the scope of the present disclosure.

A UE derives CSI from DL CSI-RS measurement, compresses the CSI using AI/ML-based CSI encoder, and send the output of the CSI encoder as the CSI report to the network 130. The network 130 receives the CSI report from the UE 116, uses it as an input to the AI/ML-based CSI decoder, and reconstructs the CSI from the UE 116. AI/ML-based CSI feedback can be regarded as one candidate for next generation CSI acquisition method that can replace the current method based on the DFT basis selection and the expression of precoding matrix via a linear combination of selected basis set such as Type-II codebook in NR.

Even if an employed CSI feedback scheme can perfectly transfer the CSI derived at the UE 116 for the current CSI reference resource to the network 130 without any loss of information, the effectiveness of the received CSI at the network 130 is still affected by channel aging.

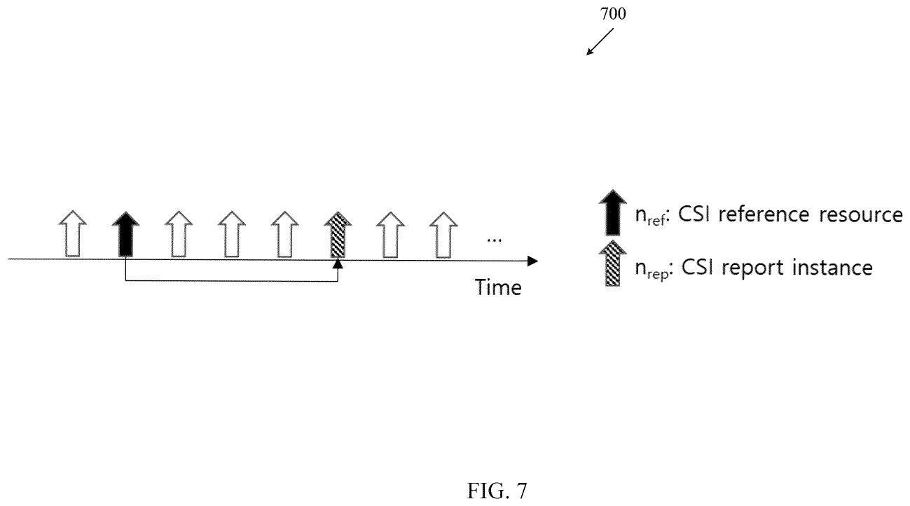

FIG. 7 illustrates an example of a timeline 700 for CSI measurement and reporting according to embodiments of the present disclosure. For example, timeline 700 for CSI measurement and reporting can be utilized by the UE 116 of FIG. 3. This example is for illustration only and can be used without departing from the scope of the present disclosure.

The channel is measured using CSI reference resource at slot n_{ref} and the derived CSI based on the channel measured at n_{ref} is sent to the network 130 at the CSI report slot nᵣₑₚ after several slots later which accounts for the processing time needed at the UE 116 to perform the channel measurement and prepare the CSI report. A denotes the time difference between n_{ref} and nᵣₑₚ. The channel aging effect refers to the fact that even at the moment when the CSI is received at the network 130 at slot nᵣₑₚ, the CSI is already outdated by the time duration A. This captures the inherent time-varying channel characteristics and the processing delay in a practical system. To mitigate such degradation caused by channel aging, future channel prediction or channel tracking is important, where the overall objective is to proactively predict what could be the actual channel state at the time it is being used, based on available observed channels. For instance, in FIG. 7, the CSI can be predicted for a future instance, e.g., nᵣₑₚ, based on the channel measurement at n_{ref} and the predicted CSI is reported at nᵣₑₚ thereby mitigating the channel aging and providing fresh information at the time of reception. Such prediction is possible as a wireless channel is, in essence, a function of its surrounding environment; hence, the channel samples are correlated over time.

The CSI prediction can be performed either at a UE or at a network, which may be dependent on the availability of information for prediction at the UE 116 or at the network 130, e.g., due to TDD/FDD system operations. Therefore, there is a need to design methods and apparatus for CSI prediction assuming when the prediction is performed at a UE and when the prediction is performed at a network.

Embodiments of the present disclosure recognize when the CSI prediction is performed at a UE, there is a need to indicate to the UE 116 one or multiple instances, including the present and future instances, for which the CSI is derived and reported.

Embodiments of the present disclosure recognize when the CSI prediction is performed at a UE for more than one instances and reported to the network 130, there is a need to enhance the CSI report message construction to reduce the feedback overhead.

Embodiments of the present disclosure recognize when the CSI prediction is performed at a network, there is a need to indicate to the UE 116 a list of beneficial assistance information feedback from the UE 116 to the network 130 to assist the CSI prediction at the network 130.

The present disclosure relates to a communication system. The present disclosure relates to defining functionalities and procedures to support predicting future CSI in cellular systems.

The present disclosure further relates to indicating to a UE one or multiple instances, including present and future instances, for which the CSI report is constructed.

The present disclosure also relates to enhancing CSI report message construction when the CSI is reported for more than one future instances.

The present disclosure further relates to indicating to and receiving from a UE the assistance information for CSI prediction.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosure herein that changes in the embodiments and examples shown may be made without departing from the scope of this disclosure.

The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Embodiments of the present disclosure relating to predicting future CSI, either performed at a UE or at a network, are summarized in the following and are fully elaborated further herein.
Method and apparatus for indicating one or multiple instances, including the present and future instances, for reporting the CSI.
Method and apparatus for reducing the CSI feedback overhead when the CSI is reported for more than one instances.
Method and apparatus for receiving assistance information, e.g., channel environment, multipath delay/Doppler profile, from a UE for CSI prediction at the network 130.

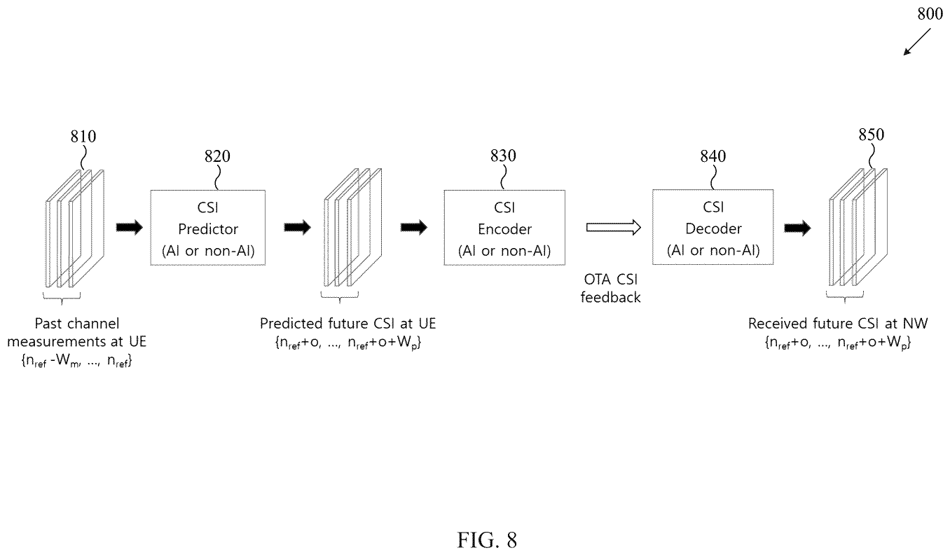

FIG. 8 illustrates a procedure 800 for an example UE CSI prediction and a transmission of the predicted CSI at a UE, and a reception the predicted CSI at a network according to embodiments of the present disclosure. For example, procedure 800 for an example CSI prediction at a UE may be performed between the gNB 102 and/or network 130 and the UE 116 in the wireless network 100 of FIG. 1. This example is for illustration only and can be used without departing from the scope of the present disclosure.

The procedure begins with 810, a UE utilizes a channel measured at the CSI reference resource at slot n_{ref} and possibly a set of past channel measurements, denoted by {n_{ref}−Wₘ, . . . , n_{ref}} with measurement window duration denoted by Wₘ. In 820, a CSI predictor is then utilized on the past channel measurements at the UE 116 for predicting CSI for future time instances. Predicted future CSI instances are denoted by {n_{ref}+o, . . . , n_{ref}+o+Wₚ}, where o is the time offset from the CSI reference resource in slot n_{ref} and Wₚ is the time window for prediction. As described, the CSI prediction can be not only for a single future instance but also for multiple instances, including the present and future instances, that is indicated to the UE 116 from the network 130, which is disclosed herein. In 830, a CSI encoder is then utilized to encode the predicted future CSI at the UE 116. The encoded CSI is sent over-the-air as CSI feedback. In 840, a CSI decoder at the gNB 102 and/or network 130 then decodes the predicted future CSI based on the received CSI feedback. In 850, the predicted future CSI is then available at the gNB 102 and/or network 130.

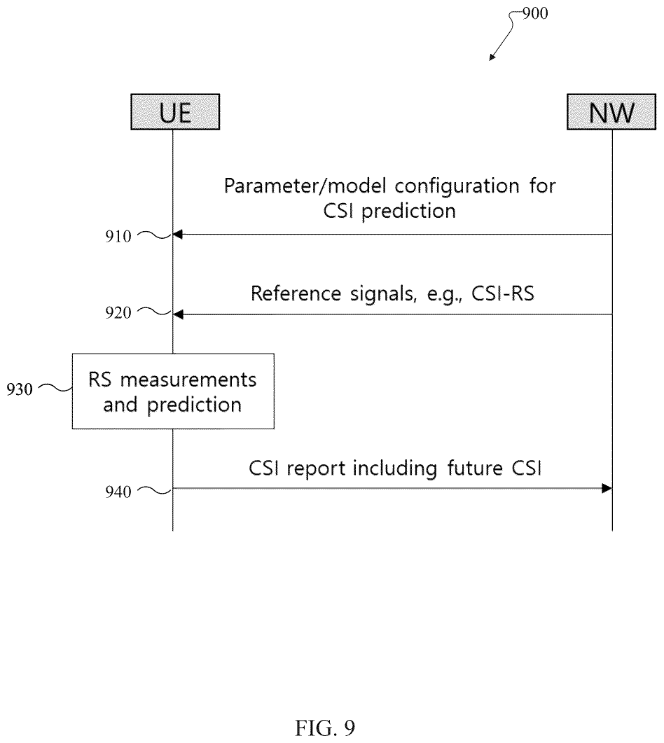

FIG. 9 illustrates a procedure 900 of an example CSI prediction performed at a UE according to embodiments of the present disclosure. For example, procedure 900 can be performed by the UE 116 and the gNB 102 and/or network 130 in the wireless network 100 of FIG. 1. This example is for illustration only and other embodiments can be used without departing from the scope of the present disclosure.

The procedure begins, in 910, a network provides parameters and/or model for CSI prediction to a UE. In 920, the network 130 then provides reference signals for channel measurement and for a UE to perform channel measurement. In 930, the UE 116 then performs CSI prediction for future instances. In 940, the UE 116 then send the CSI report to the network 130 according to embodiments of the present disclosure.

Once the UE 116 predicts CSI for future instances, the information can be encoded into a CSI report and transmitted to the network 130 via various methods. In one example, the CSI report message is encoded using a common Type-I or Type-II codebook. In another example, the CSI report message is encoded using AI/ML-based CSI compression method as illustrated in FIG. 6. In yet another example, the AI/ML-based CSI compression method as illustrated in FIG. 6 is trained to generate the CSI encoder output for future predicted CSI, instead of first predicting and then compressing in two stages as illustrated in FIG. 8. When CSI is reported for more than one instance, including the present and future instances, it can be compressed in time domain as well as in spatial and frequency domains by using either enhanced Type-II codebook with Doppler domain basis selection or an AI/ML-based three-dimensional joint compression method. Alternatively, the CSI report for multiple instances can be separately encoded and transmitted to the network 130 either in one report or multiple individual reports.

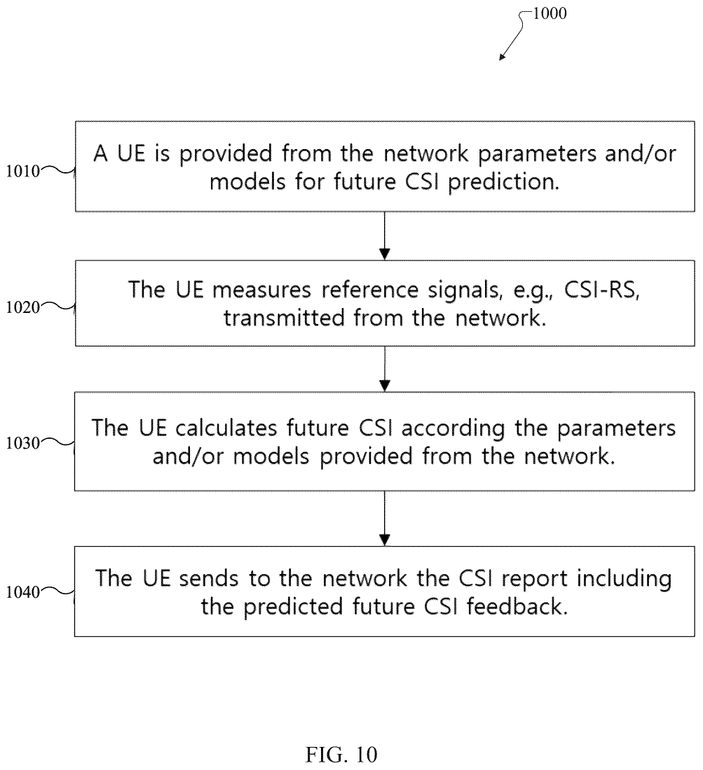

FIG. 10 illustrates a flowchart of an example UE procedure 1000 for CSI prediction according to embodiments of the present disclosure. For example, procedure 1000 for CSI prediction can be performed by any of the UEs 111-116 of FIG. 1, such as the UE 116 of FIG. 3, and a corresponding procedure can be performed by the network 130 of FIG. 1. This example is for illustration only and other embodiments can be used without departing from the scope of the present disclosure.

The procedure starts with 1010, a UE is provided from the network 130 parameters and/or models for future CSI prediction. The parameters that can be provided by the network 130 to the UE 116 includes those related to CSI measurement window, CSI prediction window or set of future instances for prediction, CSI report format, and prediction model including but not limited to AI/ML-based CSI prediction, Extended Kalman Filter (EKF)-based prediction, etc. In 1020, the UE 116 then measures reference signals transmitted from the network 130. The reference signals include CSI-RS as well as synchronization signal block (SSB), tracking reference signal (TRS), and/or any signal transmitted from the network 130 that the UE 116 can utilize to estimate the channel. In 1030, the UE 116 then calculates the future CSI according to the parameters and/or models provided from the network 130. In 1040, the UE 116 sends to the network 130 the CSI report including the predicted future CSI feedback. The CSI feedback report format follows the indication from the network 130 provided in 1010.

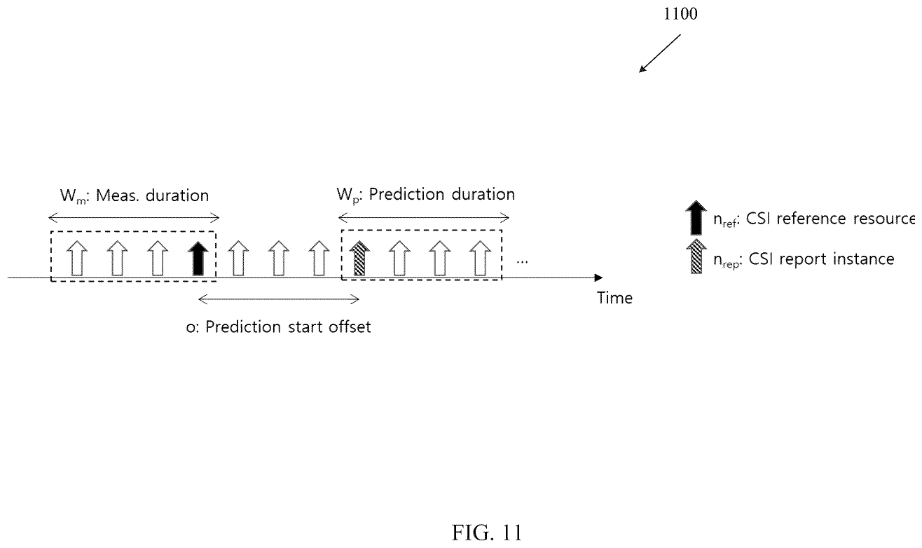

FIG. 11 illustrates an example timeline 1100 of CSI measurement window and CSI prediction window indications according to embodiments of the present disclosure. For example, timeline 1100 for CSI measurement window and CSI prediction window indications can be utilized by the UE 116 of FIG. 3. This example is for illustration only and other embodiments can be used without departing from the scope of the disclosure.

A UE can predict future CSI based on the measurement window indicated by the network 130. In one example, the measurement window can be indicated to the UE 116 with duration and an optional offset from the CSI reference resource, e.g., {n_{ref}−Wₘ, . . . , n_{ref}}, where Wₘ is the measurement window duration, and no offset is configured in this example.

A UE can be indicated by the network 130 the prediction window for which the UE 116 predicts future CSI. In one example, the prediction window can be indicated to the UE 116 with duration and offset from the CSI reference resource, e.g., {n_{ref}+o, . . . , n_{ref}+o+Wₚ}, where Wₚ is the prediction window duration and o is the prediction start offset from the CSI reference resource. Various configurations are possible. For example, if both Wₚ and o are set to zero, then the prediction window indication falls back to the legacy feedback scheme reporting CSI for the CSI reference resource at slot n_{ref}. If Wₚ is set to zero but o is set to a positive integer, the prediction window simplifies to an indication for a single future instance. If both Wₚ and o are set to positive integers, then the prediction window indicates a burst of instances starting from n_{ref}+o for the duration of Wₚ for CSI prediction. Similar to the examples herein, the prediction window can be indicated to the UE 116 with duration and offset relative to the CSI report instance, nᵣₑₚ, i.e., {nᵣₑₚ+o, . . . , nᵣₑₚ+o+Wₚ}. In this case, the offset can take any integer value including negative and zero values.

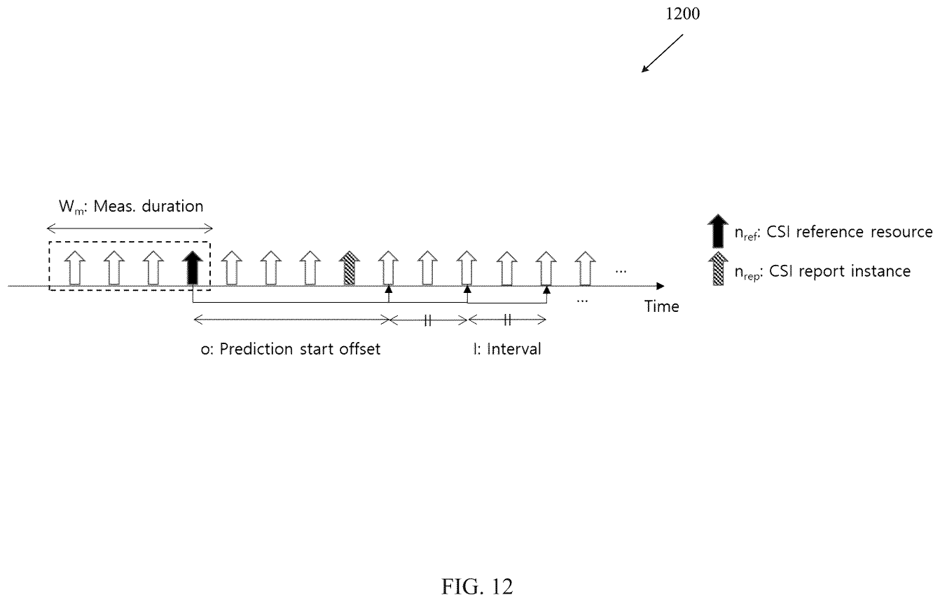

FIG. 12 illustrates an example timeline 1200 of indicating instances for CSI prediction according to embodiments of the present disclosure. For example, timeline 1200 for indicating instances for CSI prediction can be utilized by the UE 116 of FIG. 3. This example is for illustration only and other embodiments can be used without departing from the scope of the disclosure.

A UE can be indicated by the network 130 the prediction start offset o, the prediction interval I, and the number of instances for prediction. In the example timeline herein, the start offset from CSI reference resource is set to 6 slots, the prediction interval is set to 2 slots, and the number of future CSI reports is set to 3. Accordingly, the UE 116 is to predict the CSI for a set of future instances of {n_{ref}+6, n_{ref}+8, n_{ref}+10}. Similarly, the start offset can be indicated relative to the CSI report instance nᵣₑₚ.

Alternatively, the UE 116 can be indicated by the network 130 a set of offset values indicating future instances for CSI prediction. For instance, the network 130 can indicate a set of offset values, e.g., {o₁, o₂, o₃}, to the LIE 116, and the LIE 116 is to predict the CSI for {n_{ref}+o₁, n_{ref}+o₂, n_{ref}+o₃}. Similarly, the start offset can be indicated relative to the CSI report instance nᵣₑₚ.

For aperiodic CSI report, all or part of information indicating future instances for prediction can be conveyed in the PDCCH providing downlink control information (DCI) triggering CSI report. For instance, the DCI triggering aperiodic CSI report can include one or multiple offset values indicating future instances for CSI prediction. Similarly, the DCI triggering aperiodic CSI report can include the prediction start offset o, the prediction interval I, and the number of instances for prediction. Similarly, the DCI triggering aperiodic CSI report can include the prediction window duration and start offset.

A UE can be provided by the network 130 multiple configurations on future instances for prediction using any of the disclosed methods herein via higher layer signaling. The UE 116 is informed by the network 130 the configuration index via PDCCH providing a DCI format. As an example, a first configuration indicates a set of future instances, e.g., by signaling a set of offset values or tuple of {offset, interval, number}, and a second configuration indicates the present instance, i.e., CSI reference resource at n_{ref}. The UE 116 can be indicated from the network 130 via DCI the configuration index to follow in preparing the CSI report between the first and the second configurations.

When a UE reports CSI for more than one instance, including the present and/or future instances, the CSI report for each instance can be self-contained or the CSI report for one instance can be relative to another instance. For instance, if the UE 116 reports the CSI for {n_{ref}+o₁, n_{ref}+o₂} instances, the elements of CSI report including but not limited to CQI, PMI, CRI, SS/PBCH resource block indicator (SSBRI), LI, RI, L1-reference signal received power (RSRP) can be separately encoded for instances of n_{ref}+o₁ and n_{ref}+o₂, resulting in standalone and self-contained reports.

Alternatively, the UE 116 can generate CSI report for one instance, e.g., n_{ref}+o₂, relative to another instance, e.g., n_{ref}+o₁. In one example, if the CQI index derived by the UE 116 for time slot n_{ref}+o₁ is c₁ and that for time slot n_{ref}+o₂ is c₂, the UE 116 may report the CQI index for time slot n_{ref}+o₂ as c₂−c₁ using a reduced number of bits. In one example, the UE 116 may report the PMI for time slot n_{ref}+o₂ by reusing the spatial and/or frequency domain basis set chosen for the PMI report for time slot n_{ref}+o₁ and merely the amplitude and/or phase coefficients including linear combination of the basis set can be separately reported for time slot n_{ref}+o₂. In another example, the UE 116 may report the PMI for time slot n_{ref}+o₂ by reusing the spatial and/or frequency domain basis set chosen for time slot n_{ref}+o₁ and the amplitude and/or phase coefficients for time slot n_{ref}+o₂ relative to the coefficients for n_{ref}+o₁, i.e., differential coefficient values, are reported using a reduced number of bits. In one example, the UE 116 may report a single RI, which commonly applies to the set of instances reported by UE. In another example, the UE 116 may report RI for time slot n_{ref}+o₂ relative to the RI for time slot n_{ref}+o₁, i.e., differential RI values. In one example, for any CSI components measured in dBm, such as CQI, CRI, etc., the UE 116 may report a quantity for time slot n_{ref}+o₂ relative to the quantity for time slot n_{ref}+o₁, i.e., differential dBm values are reported using a reduced number of bits.

If the difference of any CSI component for time slot n_{ref}+o₂ from that of a reference at time slot n_{ref}+o₁ is smaller than a certain threshold value, the UE 116 may skip reporting such component or the entire report for time slot n_{ref}+o₂. Such a threshold value, which may be individually set for each of CQI, PMI, CRI, SSBRI, LI, RI, L1-RSRP, can be provided by the network 130 to the UE 116 or defined by specification. In one example, the UE 116 may skip sending the entire CSI report for time slot n_{ref}+o₂ if the CQI predicted for time slot time slot n_{ref}+o₂ is within a certain range from the CQI measured/predicted for time slot time slot n_{ref}+o₁. In other words, if |CQIₜ₁−CQI_{ref}|≤T, then the CSI report for time slot t1 is skipped by UE where the threshold value T can be provided by the network 130 to the UE 116.

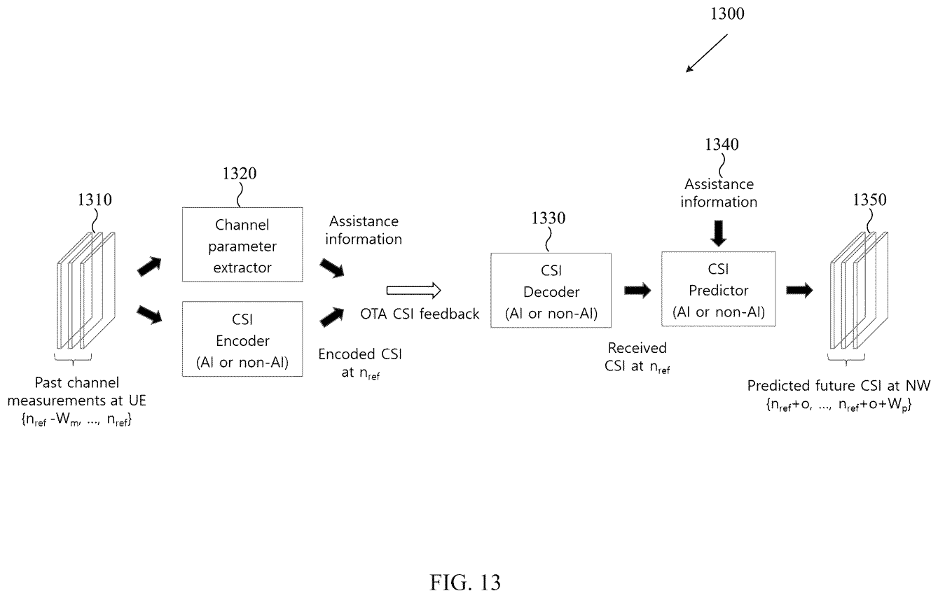

FIG. 13 illustrates a procedure 1300 of an example CSI prediction at a network according to embodiments of the present disclosure. For example, procedure 1300 may be performed between the gNB 102 and/or network 130 and the UE 116 in the wireless network 100 of FIG. 1. This example is for illustration only and other embodiments can be used without departing from the scope of the present disclosure.

In 1310, past channel measurements are done at a UE. In 1320, assistance information is then extracted by a channel parameter extractor and CSI at n_{ref} is encoded by a CSI encoder. Both the assistance information and encoded CSI are sent over-the-air to the network 130. In 1330, the encoded CSI is then decoded by a CSI decoder. In 1340, the assistance information and CSI at n_{ref} is then received by the CSI predictor. In 1350, the predicted future CSI is then at the network 130.

A UE provides various assistance information for CSI prediction to the network 130 and the CSI prediction is performed at the network 130 utilizing the assistance information received from the LIE 116. A LIE utilizes a channel measured at the CSI reference resource at slot n_{ref} and possibly a set of past channel measurements, denoted by {n_{ref}−Wₘ, . . . , n_{ref}} with measurement window duration Wₘ, for deriving assistance information feedback to the network 130. The derived assistance information may be transmitted to the network 130 separately from the CSI feedback for the CSI reference resource n_{ref} or they may be jointly transmitted to the network 130.

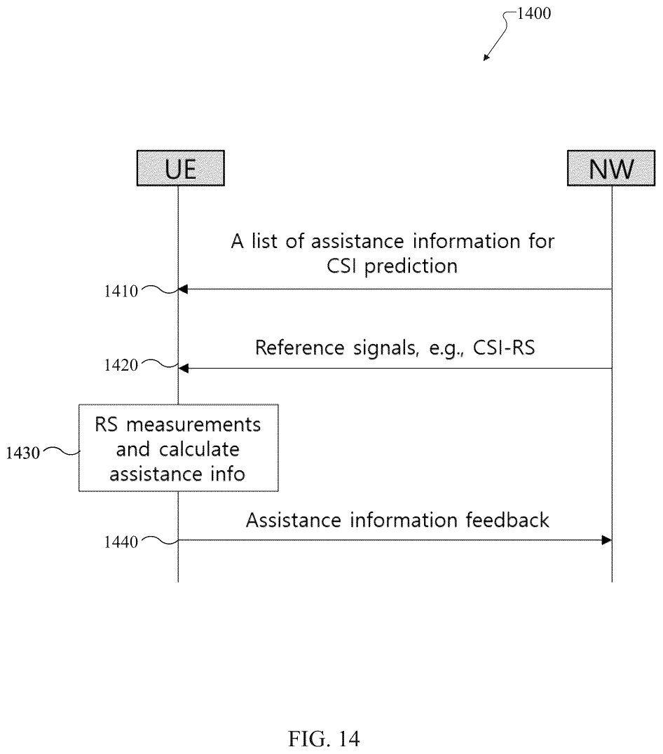

FIG. 14 illustrates a procedure 1400 of an example CSI prediction performed at a network according to embodiments of the present disclosure. For example, procedure 1400 for an example CSI prediction at a network can be performed by the UE 116 and the gNB 102 and/or network 130 in the wireless network 100 of FIG. 1. This example is for illustration only and other embodiments can be used without departing from the scope of the present disclosure.

The procedure begins with 1410, a network provides a list of assistance information requested for CSI prediction at a gNB and/or network to a UE. In 1420, the network 130 then provides reference signals to the UE 116 for channel measurement and to perform CSI prediction based on the assistance information received from the UE 116. In 1430, the UE 116 then performs channel measurement and calculates assistance information. In 1440, the UE 116 then sends the assistance information feedback to the network 130.

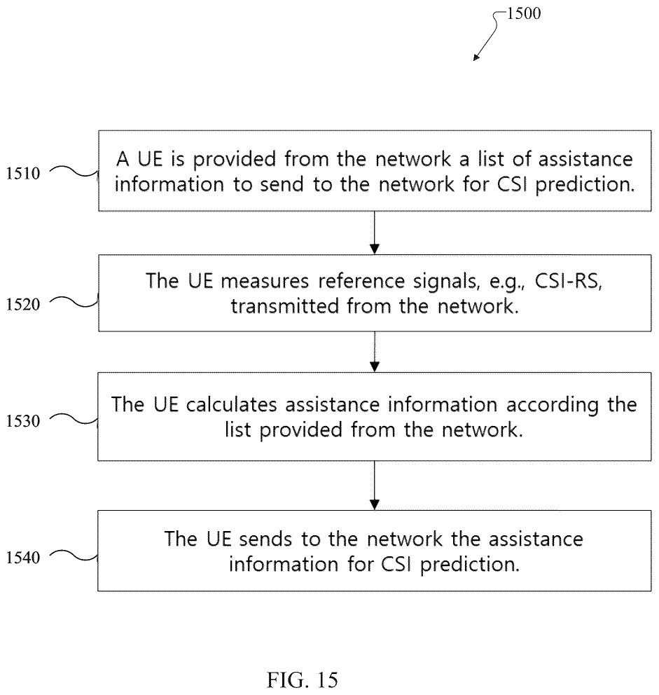

FIG. 15 illustrates a flowchart of an example UE procedure 1500 for providing assistance information to a network for CSI prediction according to embodiments of the present disclosure. For example, procedure 1500 for providing assistance information to a network for CSI prediction can be performed by any of the UEs 111-116 of FIG. 1, and a corresponding procedure can be performed by the network 130 of FIG. 1. This example is for illustration only and other embodiments can be used without departing from the scope of the present disclosure.

The procedure begins with 1510, a UE is provided from the network 130 a list of assistance information to send to the network 130 for CSI prediction. The assistance information may include UE perceived channel environment, multipath delay/Doppler profile, etc. The UE 116 may be also provided by the network 130 on the CSI measurement window via indication on the duration and an optional offset from the CSI reference resource, e.g., {n_{ref}−Wₘ, . . . , n_{ref}}, or from the CSI report instance, similarly as illustrated in FIG. 11. In 1520, the UE 116 then measures reference signals, e.g., CSI-RS, transmitted from the network 130. The reference signals include CSI-RS as well as SSB, TRS, and/or any signal transmitted from the network 130 that the UE 116 can utilize to estimate the channel. In 1530, the UE 116 then calculates assistance information according to the list provided from the network 130. In 1540, the UE 116 then sends to the network 130 the assistance information for CSI prediction.

A UE provides various assistance information for CSI prediction to the network 130 including, but not limited to, UE perceived channel environment, Doppler profile and/or multipath profile. In one example, the UE 116 perceived channel environment may include indications on UMa/UMi/InH/rural, clutter/blockage presence/density/severity, LOS/NLOS indication, indoor/outdoor indication, in-car indication, in-building indication, mobility in terms of velocity or categorization of speeds, e.g., pedestrian/vehicle/high-speed train, etc. In one example, the Doppler profile may include Doppler spread, Doppler shift, relative Doppler shift. In one example, the multipath profile may include delay spread, and per-path weight, delay, Doppler value per each signal propagation path. The UE 116 may be provided by the network 130 a threshold for signal strength such that the weight, delay, Doppler values are reported to the network 130 for paths whose strength is greater than the threshold. The strength can be expressed in terms of amplitude or power of the signal. The strength can be measured by averaging the values over the subcarriers and/or symbols carrying reference signals or taken as the maximum values over the subcarriers and/or symbols carrying reference signals.

Embodiments of the present disclosure recognize the choice of a proper CSI prediction model can be dependent on UE's channel environment and processing capability. Therefore, there is a need to define a new set of signaling to indicate UE's capability related to CSI prediction and assistance information on UE's channel environment to assist the network 130 to configure a proper CSI prediction model for the UE 116.

The performance of the currently configured CSI prediction model may degrade over time as the UE's channel environment changes. Therefore, there is a need to define a metric to measure the effectiveness of the currently used CSI prediction model and a new set of signaling to send the performance monitoring result from the UE 116 to the network 130.

If it is deemed that the currently used CSI prediction model is ineffective, the current prediction model may need to be updated, switched, or disabled. Therefore, there is a need to define a new set of signaling to support such model update, switch, and disabling operations.

The present disclosure relates to a communication system. The disclosure relates to defining functionalities and procedures to support lifecycle management for CSI prediction in cellular systems.

The present disclosure further relates to indicating UE's capability related to CSI prediction and assistance information on UE's channel environment.

The present disclosure also relates to defining performance metric to measure the effectiveness of CSI prediction model, monitoring the performance of the used CSI prediction model, and reporting to the network 130.

The present disclosure further relates to indicating switching, updating, and disabling the used CSI prediction model.

Embodiments of the present disclosure for lifecycle management for CSI prediction in cellular systems are summarized in the following and are fully elaborated further herein.
Method and apparatus for indicating UE's capability related to CSI prediction and assistance information on UE's channel environment.
Method and apparatus for measuring the effectiveness of the used CSI prediction model and reporting the performance monitoring result.
Method and apparatus for signaling switching, updating, and disabling the used CSI prediction model.

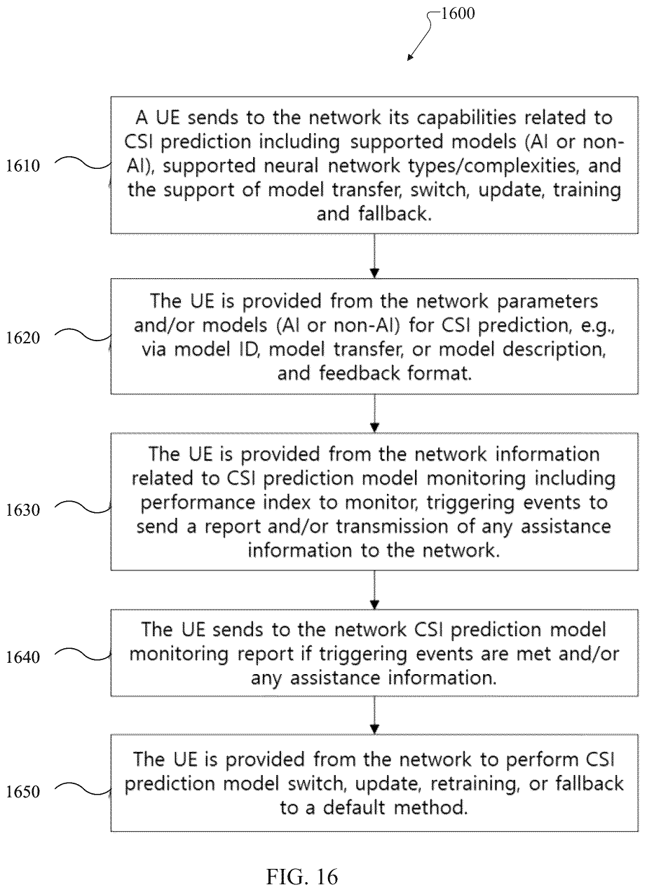

FIG. 16 illustrates a flowchart of an example UE procedure 1600 for supporting lifecycle management for CSI prediction. For example, procedure 1600 for supporting lifecycle management for CSI prediction can be performed by the UE 116 of FIG. 3, and a corresponding procedure can be performed by the network 130 of FIG. 1. This example is for illustration only and other embodiments can be used without departing from the scope of the present disclosure.

The procedure begins with 1610, a UE sends to the network 130 its capabilities related to CSI prediction including supported models, either AI/ML-based or non-AI/ML-based, supported neural network types/complexities, and the support of model transfer, switch, update, training, and fallback. Such signaling can be a part of initial system registration or handover process, which may be in response to UECapabilityEnquiry message from the network 130. In 1620, a UE is then provided from the network 130 parameters and/or models for CSI prediction, either AI/ML-based or non-AI/ML-based, e.g., via model ID, model transfer, or model description, and feedback format. In 1630, the UE 116 is then provided from the network 130 information related to CSI prediction model monitoring including performance index to monitor, triggering events to send a report and/or transmission of any assistance information to the network 130. In 1640, the UE 116 then sends to the network 130 CSI prediction model monitoring report if triggering events are met and/or any assistance information. In 1650, the UE 116 is then provided from the network 130 to perform CSI prediction model switch, update, retraining, or fallback to a default method.

With reference to FIG. 16, shown is an example procedure for a UE to provide UE capability related to CSI prediction, to receive parameters and models for CSI prediction, to perform model performance monitoring, and to receive CSI prediction model update, switch, and/or fallback is discussed.

With reference to 1610 of FIG. 16, the UE 116 capability signaling may include an indication on whether the UE 116 supports CSI prediction or not. For example, it can be Boolean indication in the capability signaling.

The UE 116 capability signaling may include an indication on the supported method for future CSI prediction. In one example, the UE 116 may indicate that it supports an AI/ML-based CSI prediction method as in FIG. 8. In another example, the UE 116 may indicate that it supports a non-AI/ML-based CSI prediction method such as Extended Kalman Filter (EKF)-based method. The UE 116 may additionally indicate whether the model parameters can be updated or reconfigured, for example, to adapt the model for a different channel environment, etc. AI/ML related UE capability signaling details will be disclosed in the present disclosure.

The UE 116 capability signaling may include an indication on the maximum time span that the UE 116 can predict, i.e., how far in the future that the UE 116 can predict. This indication may be associated with additional indications on the UE 116's channel environment, such as UE speed, and/or confidence or reliability of the prediction.

The UE 116 capability signaling may include an indication on the maximum number of predictions that the UE 116 can support, i.e., how many future instances that the UE 116 can predict.

The UE 116 capability signaling may include an indication on the processing latency associated with the CSI prediction, i.e., the processing time needed for the UE 116 to perform prediction and prepare the CSI report message, which may be in terms of the number of symbols and/or slots.

The UE 116 capability signaling may include an indication on the confidence and/or reliability of CSI prediction, i.e., the accuracy of the CSI prediction in a certain measure such as in normalized mean squared error (NMSE), cosine similarity, etc., which may be provided separately for different channel environment, e.g., LOS/NLOS, UMa/UMi/InH/rural, different UE speed, etc.

If the UE 116 indicates the support of AI/ML-based CSI prediction, the UE 116 capability signaling may further include an indication on the UE 116's AI/ML related capabilities. In one example, the UE 116 capability signaling may include an indication on the supported neural network capabilities. For example, the capability information may include the supported neural network types such as Perceptron, Feed Forward, CNN (Convolutional Neural Network), RNN (Recurrent Neural Network), LSTM (Long Short-Term Memory), GAN (Generative Adversarial Networks), Attention layer, Transformer, etc. As another example, the capability information may include a level of supported neural network complexities such as in terms of the number of layers, neurons, connections, parameters, floating-point operations per second (FLOPs), or in terms of the size of the model, e.g., in kilobytes, megabytes, etc. As another example, the capability information may include supported neural network activation functions such as logistic (sigmoid), hyperbolic (tanh), and rectified linear unit (ReLU) functions, etc.

In another example, the UE 116 capability information includes an indication on the list of supported AI/ML models for CSI prediction. For example, the UE 116 may have multiple site-specifically trained models. As an example, it can be a sequence of Boolean indication for the support of CSI prediction models trained for different channel environments including, but not limited to, urban macrocells (Uma)/urban microcells (Umi)/indoor hotspot (InH)/rural, line-of-sight (LOS)/non-LOS (NLOS), and a set of different UE speeds, etc.

In another example, the UE 116 capability information includes an indication on the types of supported training modes. For example, it can indicate whether the UE 116 supports online/offline training, and/or transferred learning, etc. For instance, the CSI prediction model can be finetuned, e.g., using transferred learning. In one example, the UE 116 may have a trained CSI prediction model for one channel environment and retrain the model for different channel environment by finetuning the parameter values of the last output layer from the previously trained prediction model while fixing the structure and parameter values for the rest of the layers. In another example, the UE 116 may use the previously trained model for one channel environment as an initialization for performing model retraining for different channel environments.

The UE 116 capability signaling may include an indication on the support of model switch, transfer, or reconfiguration. The model switch capability relates to the capability that the UE 116 can switch CSI prediction model among multiple models that the UE 116 supports. The model switching capability may also include the latency warranted by the UE 116 to perform model switching. The model transfer capability relates to the capability that the UE 116 can operate the model that it received from the network 130 in a compiled format or through a model description. The model reconfiguration capability relates to the capability that the UE 116 can update the neural network parameters and/or structure from one setting to another setting. The structural neural network update may include increasing/decreasing the number of layers, updating connections between layers, changing the order of placing the layers, enabling/disabling feed forward skip connections or concatenations.

With reference to 1620 of FIG. 16, in order to assist the network 130 to configure a proper CSI prediction model, a UE may provide assistance information to the network 130 as a model can be differently configured for a different environment. In one example, the assistance information may include UE's channel environment, such as UMa/UMi/InH/rural, clutter/blockage presence/density/severity, LOS/NLOS indication, indoor/outdoor indication, in-car indication, in-building indication, mobility in terms of velocity or categorization of speeds, e.g., pedestrian/vehicle/high-speed train, etc. The assistance information may also include confidence and/or reliability of a prediction model for different channel environment.

If a UE supports merely one CSI prediction model, the network 130 may indicate the UE 116 activation/deactivation of CSI prediction using a Boolean indication. If the UE 116 supports more than one CSI prediction models, the network 130 may indicate the UE 116 a chosen CSI prediction model using model ID. In this case, multiple models supported by the UE 116 can be registered to the network 130 during UE capability indication and assigned with unique IDs. Deactivation of the CSI prediction can be indicated separately using Boolean indication or by indicating a certain reserved value in the model ID, e.g., null.

The UE 116 may receive a CSI prediction model transferred from the network 130 or according to the model description received from the network 130 including model structure, and/or parameter values. The transferred model or provided model description shall remain within the indicated UE capability.

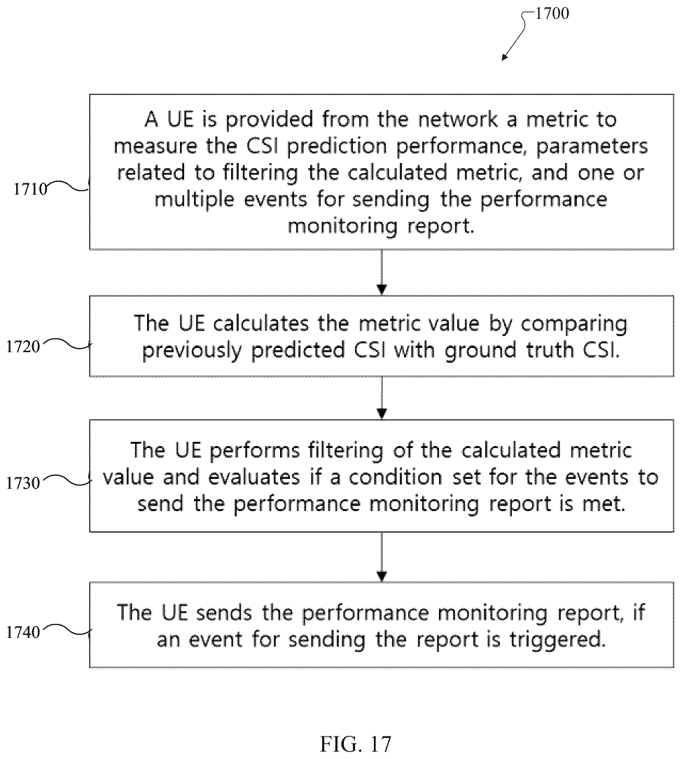

FIG. 17 illustrates a flowchart of an example UE procedure 1700 for monitoring the CSI prediction performance according to embodiments of the present disclosure. For example, procedure 1700 can be performed by the UE 116 of FIG. 3, and a corresponding procedure can be performed by the network 130 of FIG. 1. This example is for illustration only and other embodiments can be used without departing from the scope of the present disclosure.

The procedure begins with 1710, a UE is provided from the network 130 a metric to measure the CSI prediction performance, parameters related to filtering the calculated metric, and one or multiple events for sending the performance monitoring report. In 1720, the UE 116 then calculates the metric value by comparing previously predicted CSI with ground truth CSI. In 1730, the UE 116 then performs filtering of the calculated metric value and evaluates if a condition set for the events to send the performance monitoring report is met. In 1740, the UE 116 then sends the performance monitoring report, if an event for sending the report is triggered.

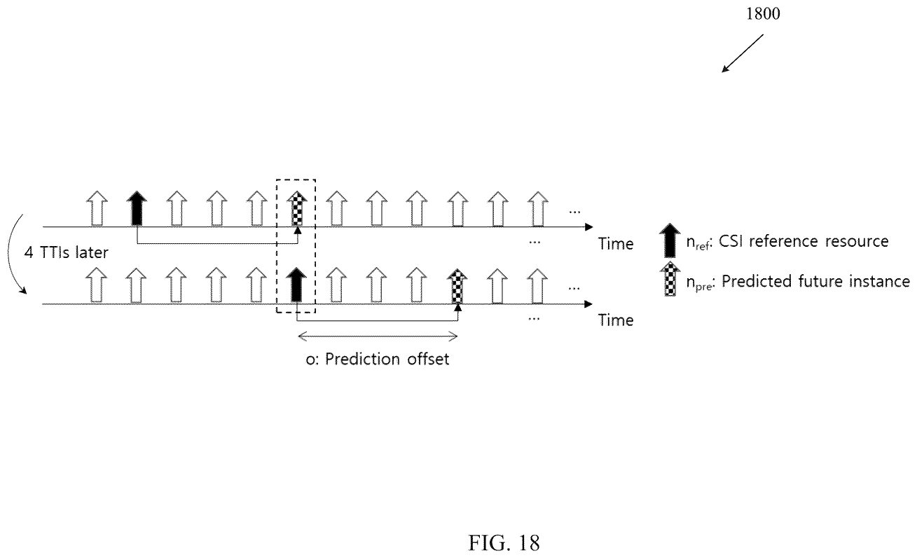

FIG. 18 illustrates an example timeline 1800 of CSI prediction performance monitoring according to embodiments of the present disclosure, for example, timeline 1800 for prediction performance monitoring can be utilized by the UE 116 of FIG. 3. This example is for illustration only and other embodiments can be used without departing from the scope of the disclosure.

As an example, the network 130 can send CSI-RS at an instance, denoted by n_{ref_new} which coincides with one of the instances for which the UE 116 predicted CSI previously, denoted by n_{ref_prev}+o. This is one way that the UE 116 obtains knowledge on the ground truth CSI for which that it previously predicted. In another example, the UE 116 may predict again the future instance n_{ref_prev}+o, that it previously predicted using CSI reference resource at n_{ref_rev}, using newer CSI reference resource later in time, denoted by n_{ref_new′}, which may not coincide with the predicted instance n_{ref_prev}+o. This is another way that the UE 116 obtains knowledge on the benchmark CSI for comparison, although the benchmark CSI is not the ground truth CSI. In another example, the UE 116 may be provided by the network 130 the ground truth CSI for comparison. For instance, in the TDD system, the network 130 may have ground truth CSI obtained from the SRS transmitted by UE and provide the ground truth CSI to the UE 116. For example, the performance monitoring report may indicate and/or include at least one of the predicted CSI, the ground-truth CSI, the performance index, and a timestamp.

The network 130 may indicate the UE 116 to send the CSI report for the present instance with the CSI reference resource at n_{ref_new}, for which the UE 116 reported the predicted CSI previously based on the CSI reference resource at n_{ref_prev}, such that the comparison between the predicted CSI for n_{ref_new} and the present ground truth CSI at n_{ref_new} can be made at the network 130.

Alternatively, the UE 116 is provided by the network 130 a metric, e.g., NMSE, cosine similarity, etc., for measuring the difference between the previously predicted CSI at n_{ref_prev} for n_{ref} new and the present ground truth CSI at n_{ref_new} and the UE 116 may be indicated by the network 130 to report the metric value with and without the present CSI at n_{ref_new}. For example, the received information related to monitoring the performance of the ML model for predicting CSI may include and/or indicate (i) a performance index for measuring a performance of the ML model for CSI prediction including: a NMSE, metrics based on cosine similarity, including squared generalized cosine similarity (SGCS), a throughput, a block error rate (BLER), and/or an acknowledgement (ACK)/negative acknowledgement (NACK) and/or (ii) information related to a monitoring periodicity.

Alternatively, the UE 116 is provided by the network 130 a metric as described earlier and threshold value(s) such that the UE 116 reports the metric value(s) with and without the present CSI, if the metric value(s) is greater or smaller than the threshold value(s). The threshold value(s) can be set for any of the CSI components including but not limited to CQI, PMI, CRI, SSBRI, LI, RI, and/or L1-RSRP. For some metrics, the smaller the value the lesser the difference between the two input CSI, e.g., NMSE. In this case, the UE 116 may send the report if the metric value is greater than a certain threshold. For some other metrics, the smaller the metric value the greater the difference between the two input CSI, e.g., cosine similarity or any variants of it. In this case, the UE 116 may send the report if the metric value is lesser than a certain threshold. For example, the UE received information related to transmitting the performance monitoring report may include/indicate at least one of (i) a triggering condition for transmitting the performance monitoring report, where the triggering condition is indicated by one or more threshold values on respective one or more performance indexes and (ii) an uplink channel (e.g., a physical uplink control channel (PUCCH)) for the transmission of the performance monitoring report.

The network 130 may indicate the UE 116 to send the present CSI and/or metric value by comparing the previously predicted CSI and the ground truth CSI. The indication can be provided to the UE 116 by the network 130 via a PDCCH providing DCI triggering aperiodic CSI report, medium access control (MAC) control element (CE), or any higher layer signaling.

The UE 116 can be indicated by the network 130 that certain predicted CSI for a future instance can be used for comparison with ground truth CSI at the future instance. For periodic CSI, the UE 116 may be implicitly indicated from the network 130 via periodic CSI configuration and the configuration for future instances for prediction. The UE 116 derives instances coinciding between the instances for CSI reference resources and instances for CSI prediction. The UE 116 then stores the predicted CSI for such coinciding instances for the purpose of comparison with ground truth CSI which will become available in the future. For aperiodic CSI, the UE 116 may be indicated by the network 130 via PDCCH providing DCI triggering aperiodic CSI report that certain predicted CSI requested by the network 130 can be used for the purpose of comparison with ground truth CSI in the future. With such an indication, the UE 116 recognizes to store the predicted CSI for future use. For aperiodic CSI, the UE 116 may be indicated by the network 130 via PDCCH providing DCI triggering aperiodic CSI report one or multiple future instances that the network 130 will configure CSI reference resource. With such an indication, the UE 116 can derive instances coinciding between the instances for future CSI reference resources and the instances that the UE 116 is requested to send the predicted CSI report. Therefore, the UE 116 stores the predicted CSI for such coinciding instances for the purpose of comparison with ground truth CSI in the future.

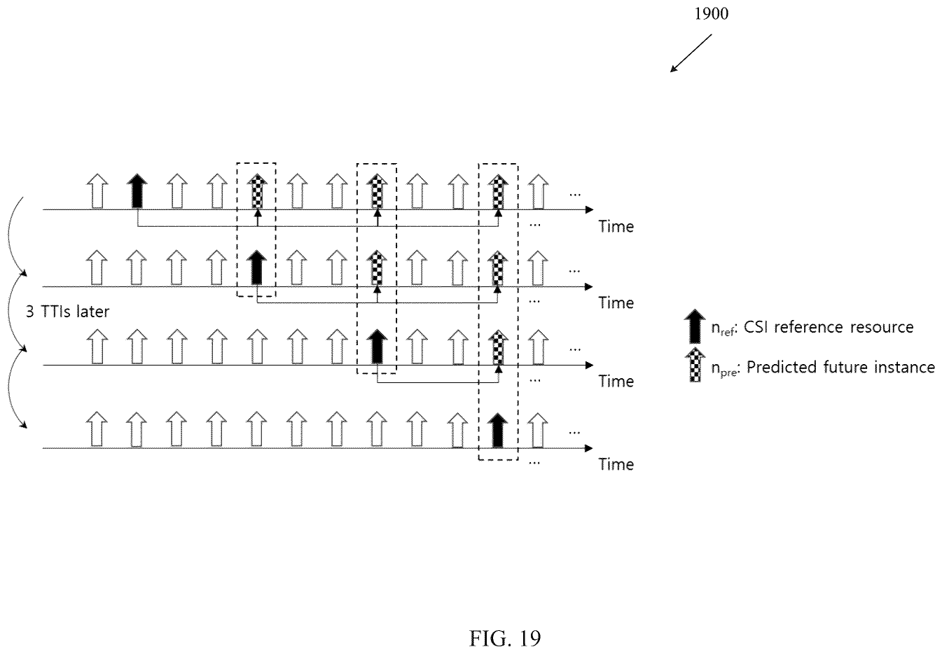

FIG. 19 illustrates an example timeline 1900 of measuring and filtering CSI prediction performance according to embodiments of the present disclosure. For example, timeline 1900 for measuring and filtering CSI prediction performance can be utilized by any of the UEs 111-116 of FIG. 1. This example is for illustration only and other embodiments can be used without departing from the scope of the disclosure.

The UE 116 is provided by the network 130 a metric, e.g., NMSE, cosine similarity, etc., for measuring the difference between the previously predicted CSI and the present ground truth CSI, and a method and/or parameters to perform averaging of such measurements. In one example, the averaging can be performed for a given instance with ground truth CSI and one or multiple previously predicted CSI for that instance. That is, Mₙ=Σₖ βₖ·M_{n,k}, where M_{n,k} is the metric value measuring the difference between the ground truth CSI with CSI reference resource at instance n and a predicted CSI at instance k for instance n, and βₖ is the weight applied for filtering the measurement M_{n,k}. A condition, such as threshold value, for events triggering the performance report can be set for Mₙ. In another example, the filtering can be performed over time with a series of measurements between ground truth CSI for a certain instance and a set of previously predicted CSI for that instance. That is, Fₙ=(1−α)·Fₙ₋₁+α·Mₙ, where Mₙ=Σₖβₖ·M_{n,k} as described earlier. The measurement Mₙ based on the CSI reference resource at instance n can be simplified to M_{n,k} without weighted summation if there is merely one previously predicted CSI for instance n. In the above equation, the factor α determines the weights between the most recent measurement Mₙ and the previous average Fₙ₋₁.

The UE 116 can be provided from the network 130 other performance index to monitor the performance of the currently used CSI prediction model and the triggering events to send the report to the network 130 when the conditions are met. The report can be also periodically triggered with the periodicity set by the network 130 or aperiodically triggered by the network 130 via L1/L2 or any higher layer signaling. As an example, a UE can be signaled from the network 130 to monitor PDCCH and/or physical downlink shared channel (PDSCH) decoding error rate and send a report if the measured error rate is larger than or smaller than an indicated or predefined target value with an optionally indicated or predefined margin or if the measured error rate goes out of an indicated or predefined target value range with max/min values. The UE 116 can be configured with a window duration in time or in number of PDCCH and/or PDSCH receptions to average and measure the error rate. The error rate can be measured for the initial reception or for the final reception if hybrid automatic repeat request (HARQ) is applied. As another example, the UE 116 can be signaled from the network 130 to monitor the received signal to noise ratio (SNR) or spectral efficiency and send a report if the measured value is larger than or smaller than a target value with an optional margin or if the measured error rate goes out of a target value range with max/min values. The target value(s) can be predefined, indicated by the network 130 or set by the UE 116 itself based on the estimated effective SNR or spectral efficiency calculated when the UE 116 obtained the CSI. The UE 116 can be configured with a window duration in time or in number of measurements, e.g., CSI-RS measurements for target value calculation, PDCCH/PDSCH measurements for received SNR or spectral efficiency calculation.

With reference to 1650 of FIG. 16, the UE 116 can be indicated from the network 130 the CSI prediction model ID via L1/L2 or higher-layer signaling to perform model switching. As an example, the switching can be part of RRC reconfiguration during handover if the UE 116 has multiple site-specifically trained models.

The UE 116 can be indicated from the network 130 via L1/L2 or higher-layer signaling to disable the CSI prediction. For example, the UE 116 may receive (e.g., from network 130 or BS 102) an indication to switch the ML model for predicting CSI to a non-ML-based CSI reporting method, determine a CSI report using the non-ML-based CSI reporting method, and transmit a channel (e.g., PUCCH) with the CSI report.

The UE 116 can be provided from the network 130 a new CSI prediction model, e.g., via model transfer, or a new model description including neural network structure, parameter values such that the UE 116 may reconfigure neural network parameter values, or both neural network structure as well as parameter values.

The UE 116 can be instructed by the network 130 to perform model retraining or finetuning, e.g., via transferred learning as described earlier The UE 116 can be provided by the network 130 the dataset or the dataset ID so that the UE 116 can download the dataset from external server for training the CSI prediction model. The UE 116 can be also provided by the network 130 one or multiple time offset values from the present towards which the CSI is predicted while the model is trained. The UE 116 can be indicated by the network 130 the cost function to be used during training, e.g., NMSE, cosine similarity, squared cosine similarity, etc. The UE 116 can be indicated by the network 130 whether full model retraining will be performed for the entire prediction model or merely the final output layer parameter values will be finetuned.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE) to report channel state information (CSI), the method comprising:
receiving:
first information related to monitoring a performance of a machine learning (ML) model for predicting CSI,
second information related to transmitting a performance monitoring report,
third information related to reception of CSI reference signals (CSI-RSs) for determining a ground-truth CSI on a cell, and
the CSI-RSs based on the third information;
determining:
the ground-truth CSI based on the reception of the CSI-RSs, and
a performance monitoring report for the ML model based on the first information and the ground-truth CSI; and
transmitting a channel with the performance monitoring report based on the second information.

2. The method of claim 1, wherein the first information indicates at least one of:
a performance index for measuring a performance of the ML model for CSI prediction including:
a normalized mean squared error (NMSE),
metrics based on cosine similarity, including squared generalized cosine similarity (SGCS),
a throughput,
a block error rate (BLER), or
an acknowledgement (ACK)/negative acknowledgement (NACK), and
information related to a monitoring periodicity.

3. The method of claim 1, wherein the second information indicates at least one of:
a triggering condition for transmitting the performance monitoring report, wherein the triggering condition is indicated by one or more threshold values on respective one or more performance indexes, and
an uplink channel for the transmission of the performance monitoring report.

4. The method of claim 1, wherein the performance monitoring report indicates at least one of:
a predicted CSI,
the ground-truth CSI,
a performance index, and
a timestamp.

5. The method of claim 1, wherein the determination of the performance monitoring report is based on one or more predicted CSIs for one or more instances in time.

6. The method of claim 1, further comprising:
receiving a physical downlink control channel (PDCCH) providing a downlink control information (DCI) format indicating to transmit the performance monitoring report; and
wherein transmitting the channel with the performance monitoring report comprises transmitting the channel with the performance monitoring report based on the reception of the PDCCH providing the DCI format.

7. The method of claim 1, further comprising:
receiving an indication to switch the ML model for predicting CSI to a non-ML-based CSI reporting method;
determining a CSI report using the non-ML-based CSI reporting method; and
transmitting a channel with the CSI report.

8. A user equipment (UE) comprising:
a transceiver configured to:
receive first information related to monitoring a performance of a machine learning (ML) model for predicting CSI,
receive second information related to transmitting a performance monitoring report,
receive third information related to reception of CSI reference signals (CSI-RSs) for determining a ground-truth CSI on a cell, and
receive the CSI-RSs based on the third information; and
a processor operably coupled to the transceiver, the processor configured to:
determine the ground-truth CSI based on the reception of the CSI-RSs, and
determine a performance monitoring report for the ML model based on the first information and the ground-truth CSI,
wherein the transceiver is further configured to transmit a channel with the performance monitoring report based on the second information.

9. The UE of claim 8, wherein the first information indicates at least one of:
a performance index for measuring a performance of the ML model for CSI prediction including:
a normalized mean squared error (NMSE),
metrics based on cosine similarity, including squared generalized cosine similarity (SGCS),
a throughput,
a block error rate (BLER), or
an acknowledgement (ACK)/negative acknowledgement (NACK), and information related to a monitoring periodicity.

10. The UE of claim 8, wherein the second information indicates at least one of:
a triggering condition for transmitting the performance monitoring report, wherein the triggering condition is indicated by one or more threshold values on respective one or more performance indexes, and
an uplink channel for the transmission of the performance monitoring report.

11. The UE of claim 8, wherein the performance monitoring report indicates at least one of:
a predicted CSI,
the ground-truth CSI,
a performance index, and
a timestamp.

12. The UE of claim 8, wherein the determination of the performance monitoring report is based on one or more predicted CSIs for one or more instances in time.

13. The UE of claim 8, wherein the transceiver is further configured to:
receive a physical downlink control channel (PDCCH) providing a downlink control information (DCI) format indicating to transmit the performance monitoring report; and
transmit the channel with the performance monitoring report based on the reception of the PDCCH providing the DCI format.

14. The UE of claim 8, wherein:
the transceiver is further configured to receiving an indication to switch the ML model for predicting CSI to a non-ML-based CSI reporting method;
the processor is further configured to determine a CSI report using the non-ML-based CSI reporting method; and
the transceiver is further configured to transmit a channel with the CSI report.

15. A base station comprising:
a transceiver configured to:
transmit first information related to monitoring a performance of a machine learning (ML) model for predicting CSI,
transmit second information related to transmitting a performance monitoring report,
transmit third information related to transmission of CSI reference signals (CSI-RSs) for determining a ground-truth CSI on a cell,
transmit the CSI-RSs based on the third information, and
receive, based on the second information, a channel with the performance monitoring report for the ML model based on the first information and the ground-truth CSI.

16. The base station of claim 15, wherein the first information indicates at least one of:
a performance index for measuring a performance of the ML model for CSI prediction including:
a normalized mean squared error (NMSE),
metrics based on cosine similarity, including squared generalized cosine similarity (SGCS),
a throughput,
a block error rate (BLER), or
an acknowledgement (ACK)/negative acknowledgement (NACK), and
information related to a monitoring periodicity.

17. The base station of claim 15, wherein the second information indicates at least one of:
a triggering condition for transmission of the performance monitoring report, wherein the triggering condition is indicated by one or more threshold values on respective one or more performance indexes, and
an uplink channel for the transmission of the performance monitoring report.

18. The base station of claim 15, wherein the performance monitoring report indicates at least one of:
a predicted CSI,
the ground-truth CSI,
a performance index, and
a timestamp.

19. The base station of claim 15, wherein the performance monitoring report is based on one or more predicted CSIs for one or more instances in time.

20. The base station of claim 15, wherein the transceiver is further configured to:
transmit a physical downlink control channel (PDCCH) providing a downlink control information (DCI) format indicating to transmit the performance monitoring report; and
receive the channel with the performance monitoring report based on the transmission of the PDCCH providing the DCI format.
